(19) United States
(12) Patent Application Publication
(10) Pub. No.: US 2025/0373091 A1
(43) Pub. Date: Dec. 4, 2025

(54) Stator for an Electric Axial Flux Machine, Method for Producing Such a Stator, and Electric Axial Flux Machine Having Such a Stator

(71) Applicant: Bayerische Motoren Werke Aktiengesellschaft, Muenchen (DE)

(72) Inventors: Markus LANG, Muenchen (DE); Korbinian KOENIG-PETERMAIER, Muenchen (DE); Robert SCHMIDT, Muenchen (DE)

(21) Appl. No.: 18/867,287

(22) PCT Filed: Jun. 23, 2023
(86) PCT No.: PCT/EP2023/067130

§ 371 Date: Nov. 19, 2024

(30) Foreign Application Priority Data
Jul. 12, 2022 (DE) 10 2022 117 272.4

(51) Int. Cl. H02K 1/18; H02K 1/14; H02K 3/52; H02K 15/022

(52) U.S. Cl. CPC H02K 1/182; H02K 1/146; H02K 3/522; H02K 15/022; H02K 2203/09

(57) ABSTRACT

A stator for an electric axial flux machine includes a support structure with two support discs having star extensions, a rotor shaft bearing, and coil units each arranged between two pairs of star extensions following one another in the circumferential direction and are thereby fixed in the circumferential direction. Respective end portions of each laminated core of the coil units project beyond the support structure in the axial direction. Radially external fixing ends of the star extensions project radially outwards beyond the coil units. The coil units are clamped radially in the direction of the rotor shaft bearing by a clamping ring. A stator outer shell is arranged between the support discs and radially surrounds the coil units in the circumferential direction, the stator outer shell being attached to the fixing ends of the star extensions for conjoint rotation.

### BACKGROUND AND SUMMARY

The present invention relates to a stator for an electric machine which is in the form of an axial flux machine. The invention also relates to a method for producing such a stator. The invention additionally relates to an electric axial flux machine which has such a stator.

Today, an ever higher specific power density is demanded when developing electric machines, in particular axial flux machines. Stators of axial flux machines are nowadays often constructed using tooth-wound coils, wherein an iron core is in the form of an SMC (soft magnetic composite). The tooth-wound coils are usually anchored or secured in a housing of the axial flux machine by a mount in a thin-walled plastic component. This plastic component is connected to a top side of the axial flux machine, so that the plastic component is situated in the air gap between a rotor and the stator. The connection between the plastic component and the top side is often merely adhesively bonded. As a result, the transmittable torques are limited by the strength/stability or firmness of the adhesive connection between the plastic component and the top side. In addition, the plastic component arranged in the air gap between the rotor and the stator leads to torque transmission being further reduced or limited. Furthermore, it is necessary to compress the individual laminations for a laminated tooth-wound coil core. A conventional stator for an electric axial flux machine and a conventional electric axial flux machine are disclosed, for example, in DE 10 2021 124 998 A1. Furthermore, EP 2 962 383 B1 discloses an electric axial flux machine, wherein stator teeth of a stator of these conventional axial flux machines are connected to each other and to a housing radially surrounding the outside of the stator by a ring structure.

An object of the present disclosure is to increase a torque transmission capability of an axial flux machine.

This object is achieved by the subjects of the present disclosure. Further possible refinements are also disclosed in the description and the figures. Features, advantages and possible refinements which are presented as part of the description for one of the subjects of the claims should be regarded at least analogously as features, advantages and possible refinements of the respective subject matter of the other claims and of every possible combination of the subjects of the claims, possibly in combination with one or more of the other claims.

The present disclosure proposes a stator for an electric axial flux machine. The stator has a support structure, coil units, a clamping ring and a stator outer shell.

The support structure has two support disks, which are arranged coaxially in relation to each other and are axially spaced apart from each other, and a rotor shaft bearing. Here, the support disks each have discrete star extensions which extend radially outward away from a circular ring portion of the support disk in a radiating manner. Therefore, the support disks can also be called support star disks or star disks. The star extensions therefore project from the circular ring portion and here lie in the same plane as the circular ring portion itself. The star extensions are all of identical design in terms of size and geometry and are equidistantly spaced apart from each other in the circumferential direction. Radially external ends of the star extensions lie on a common circumscribed circle, the center point of the circumscribed circle and a center point of the circular ring portion coinciding. The center points lie on a longitudinal center axis of the support structure, and the longitudinal center axis of the support structure coincides with a longitudinal center axis of the rotor shaft bearing.

The coil units are each arranged between two pairs of star extensions, which follow one another in the circumferential direction, of the support disks. In this case, the coil units directly adjoin the pairs of star extensions, as a result of which the coil units are fixed with respect to the support structure in the circumferential direction. A pair of star extensions is formed here from a star extension of one of the support disks and a star extension, arranged at the same angle, of the other of the support disks. The support disks are arranged for conjoint rotation relative to each other.

The respective coil unit has a laminated core which is formed in particular from a lamination stack, the individual laminations of which are stacked or laminated in the radial direction. Respective end sections of each laminated core of the coil units project beyond the support structure in the axial direction. In other words, the respective laminated core of each coil unit projects beyond the support disks along the longitudinal center axis of the support structure on both sides. The star extensions of the support disks have radially external fixing ends which project radially outward beyond the coil units. In other words, a first radius (measured from the longitudinal center axis of the support structure up to the fixing ends) is larger than a second radius (measured from the longitudinal center axis of the support structure up to a radially external edge of the respective laminated core).

The coil units are radially clamped in the direction of the rotor shaft bearing by the clamping ring by way of the clamping ring being clamped around the end sections of the coil units in the circumferential direction. In particular, the clamping ring is formed in one piece. For example, provision can be made for the clamping ring to be radially widened by a clamping force and/or in a thermal manner and to then be placed around the end sections of the coil units. As soon as the clamping force and/or the thermal effect are/is removed, the clamping ring radially constricts, as a result of which the coil units are clamped in the direction of the rotor shaft bearing or the longitudinal center axis of the support structure. For this purpose, an inside radius of the clamping ring can be smaller than the second radius. A force-fitting connection, in particular by a press-fit, prevails between the clamping ring, that is to say the inner contact surface of the clamping ring, and the end sections of the coil units.

The stator outer shell is arranged between the support disks and surrounds the coil units in a radially covering manner in the circumferential direction. In addition, the stator outer shell is attached to the fixing ends of the star extensions for conjoint rotation with respect to the support structure. In particular, the stator outer shell is designed to function as an outer structure for a torque support. For example, for this purpose, the stator outer shell can have a supporting block which is designed to function as a torque support with a mating bearing of a housing of the axial flux machine.

The supporting disks and/or the clamping ring and/or the stator outer shell can be formed from a metal material. A fiber-reinforced material is also conceivable.

During operation of the axial flux machine, the individual laminations of the coil units or laminated cores are not pulled out of the stator by the magnetic forces acting during operation on account of the radially laminated cores being clamped between the support structure and the clamping ring. In this case, form-fitting connection of the individual laminations can be dispensed with, as a result of which production of the stator is simplified. In general, the stator described here can be produced in a particularly simple, in particular automated, manner since the individual elements of the axial flux machine are particularly suitable for being handled by a machine, in particular a robot. In this case, particularly high torques can be transmitted in comparison to conventional stators since support of the individual laminations of the laminated cores by a plastic part is dispensed with in comparison to the prior art.

According to one possible development of the stator, provision is made for the support structure to have a rotor bearing cylinder. In this case, the respective support disk is connected in a force-fitting, interlocking and/or integrally bonded manner, in particular screwed, to the rotor bearing cylinder at a respective end face of the rotor bearing cylinder. This results in the support disks being axially spaced apart from each other over a length of the rotor bearing cylinder. In particular, the rotor bearing cylinder is in the form of a circular ring cylinder, wherein an inner circumferential surface of the rotor bearing cylinder or circular ring cylinder is designed to function as a bearing point for a rotor shaft of the axial flux machine. This means that the rotor shaft bearing can be formed by the rotor bearing cylinder. As a result, the rotor shaft can be particularly efficiently supported in the center of the axial flux machine or coaxially in relation to the longitudinal center axis of the support structure. In general, provision can be made for the support structure to be formed in one piece by way of, for example, the support disks and the rotor bearing cylinder being formed in one piece with each other. As an alternative, the support structure may be a multipartite structure, wherein the support disks and the rotor shaft bearings, in particular the rotor bearing cylinder, are provided separately from each other and connected to each other in a force-fitting, interlocking and/or integrally bonded manner to form the support structure. In any case, the rotor bearing cylinder has a dual functionality, specifically—firstly—the rotor bearing cylinder functions as the rotor shaft bearing and—secondly—the rotor bearing cylinder functions as a connecting element by which the two support disks are connected to each other for conjoint rotation.

In a further possible refinement of the stator, the stator has one or more centering cylinders. The respective centering cylinder is arranged coaxially on the circular ring portion of the support disk and extends axially away from the coil units. Here, the coil units, by way of their end sections, are supported on an outer circumferential surface of the centering cylinder and are clamped between the centering cylinder and the clamping ring in the radial direction. In particular, provision is made for the stator to have such a centering cylinder for each support disk, which means that the stator has, for example, two centering cylinders. Therefore, the coil units can be held particularly efficiently and securely fixed in position between the pairs of star extensions of the support disks. Owing to the centering cylinder/centering cylinders, the stator can be manufactured while complying with advantageously particularly low tolerances, such particularly low tolerances being expedient for a particularly high torque transmission capability of the axial flux machine. This is because the coil units are arranged in a particularly exactly circular manner in this way.

In conjunction with the centering cylinder, provision is made in a further possible refinement of the stator for two or more alignment pins to be formed on the (respective) circular ring portion of the support disk, the alignment pins each extending outward axially away from the circular ring portion. Here, the alignment pins are designed to assist with coaxially aligning the centering cylinder with respect to the support disk. Thus, when putting together or assembling the elements of the axial flux machine, in particular the stator of the axial flux machine, coaxial alignment of the centering cylinder with respect to the support disk is particularly simple and/or involves particularly little effort, wherein the centering cylinder and the support disk are nevertheless aligned particularly exactly coaxially with each other. This is because provision is made for a longitudinal center axis of the centering cylinder and the longitudinal center axis of the support structure to coincide.

In a further possible refinement of the stator, the respective coil unit has a bar support body which is formed from an electrically insulating material. The bar support body has, as ends, two supporting blocks, so that the contacting support ends at the supporting blocks or by the supporting blocks along its axial longitudinal extent, that is to say on both sides. In the case of the stator, the bar support body is radially supported on the clamping ring by the supporting blocks. In particular, the bar support body is directly or indirectly attached to the laminated core. Owing to the bar support body being supported on the clamping ring by the supporting blocks of the bar support body, the respective coil unit is particularly securely fixed between the pairs of star extensions of the support disks by the bar support body and by the laminated core.

The idea of particularly positionally secure fixing of the respective coil unit between the pairs of star extensions of the support disks is especially taken into account if-as provided in a further possible refinement of the stator-the bar support body is radially fixed between the clamping ring and the stator outer shell by way of the supporting blocks being clamped in the direction of the clamping ring by the stator outer shell. This particularly reliably prevents the coil units from unintentionally or undesirably being pushed radially outward since this radial pushing-out is blocked firstly by the clamping ring and secondly by the stator outer shell in conjunction with the respective bar support body.

A further possible refinement of the stator makes provision for the respective coil unit to have an electric coil and for the stator to have a busbar arrangement. The busbar arrangement has a plurality of busbars which are axially spaced apart from each other and are arranged on the outer circumference between the stator outer shell and the coil units. Here, the respective busbar is electrically contact-connected to two or more of the electric coils. If the axial flux machine is, for example, a three-phase electric machine, the busbar arrangement has four busbars, three of the busbars representing the three phases and the fourth busbar being used to realize a star point circuit. At any rate, the busbar arrangement is designed to function as a so-called stator circuit. For this purpose, the busbar arrangement has, in particular, a phase interface which is designed to be electrically contact-connected to an electrical energy supply, so that electrical drive energy, by which the rotor of the axial flux machine can be driven, can be provided to the stator via the phase interface during operation of the axial flux machine.

The bar support bodies function, in particular, as supports or support elements for the busbars of the busbar arrangement. For this purpose, the bar support bodies can be thinner between the supporting blocks, that is to say between the ends of the respective bar support body, so that a receiving space for the busbars is formed between the supporting blocks. Since the bar support body is formed from the electrically insulating material, for example plastic, the busbars are electrically insulated from each other even though two or more of the busbars may be arranged in the receiving space of the respective bar support body and make direct contact with the bar support body. In addition, the bar support body functions as an electrical insulation element between the busbars and the respective coil.

As proposed in a further possible refinement, the bar support body of the stator can have two coil contacting elements which are electrically insulated from each other and are each electrically conductively connected to a respective busbar contacting element of the bar support body. Here, coil ends of the coil of the corresponding coil unit are each electrically conductively contact-connected to one of the coil contacting elements. Furthermore, one of the busbars is electrically conductively connected to one of the busbar contacting elements and another of the busbars is electrically conductively connected to another of the busbar contacting elements. In particular, respective conductor tracks which electrically conductively connects the respective coil contacting element and the associated busbar contacting element are embedded into the electrically insulating material of the bar support body. In other words, provision can be made for the conductor tracks by which the respective coil contacting element and the correspondingly associated one of the busbar contacting elements are electrically conductively connected to be encapsulated by the electrically insulating material of the bar support body. The coil contacting element is, in particular, in the form of a socket, wherein the corresponding one of the coil ends can be embodied as a plug-in element corresponding to the socket. The busbar contacting element is, for example, in the form of a contacting pin which extends out of the bar support body or out of the electrically insulating material of the bar support body starting from the corresponding conductor track. This contacting pin extends, in particular, into the receiving space for the busbars. The coil contacting element into which the corresponding coil end can be inserted, as a result of which the coil contacting element and the corresponding coil end are then electrically contact-connected to each other, can be formed, in particular, on the respective supporting block of the bar support body. In order to ensure a particularly secure electrical connection between the busbars and the busbar contacting elements, provision is made, in particular, for the busbars and the busbar contacting elements, in particular the contacting pins, to be attached to each other by a thermal connection process, for example welding.

The bar support body therefore not only functions as a further connecting or stabilizing element for the respective coil unit, but rather additionally as an electrical connecting element between the busbars and the coils of the coil units. As a result, the stator of the axial flux machine can be produced in a particularly simple manner and/or with particularly little effort since it has a particularly small number of individual components.

In accordance with a further possible embodiment of the stator, the stator outer shell has two half-shells which butt against each other and are connected to each other in the circumferential direction by two connecting blocks. In particular, provision is made for the two half-shells for the stator outer shell to be identical parts. The respective connecting block has one of the connecting elements of the first half-shell and one of the connecting elements of the second half-shell. In this case, the connecting elements extend away radially outward starting from an outer circumferential surface of the respective half-shell, which means that the respective connecting element projects radially from the respective half-shell starting from the outer circumferential surface of the respective half-shell. This leads to the respective connecting block being able to be used for torque support. For example, the respective connecting block functions as a respective supporting block of the stator.

Owing to the stator outer shell having the two half-shells, which are connected to each other by the connecting blocks, production of the stator is particularly simple and/or involves particularly little effort since the stator outer shell can be arranged around the coil units, in particular around the bar support bodies, in the circumferential direction in a particularly simple manner. In addition, the stator outer shell can be particularly efficiently radially clamped against the coil units, in particular bar support bodies, so that the bar support bodies and consequently the coil units are particularly reliably blocked against being radially pushed out.

The present disclosure further relates to an electric machine, in particular an axial flux or diagonal flux machine, which has the stator described in this document as the stator.

The present disclosure also relates to a method for producing the stator for the axial flux machine. The support structure comprising the two support disks is provided in the method. The coil units are arranged between two pairs of star extensions, which follow one another in the circumferential direction, of the support disks, as a result of which the coil units are fixed with respect to the support structure in the circumferential direction. In addition, the coil units are radially clamped in the direction of the rotor shaft bearing by way of the clamping ring being clamped around the end sections of the coil units in the circumferential direction. Furthermore, the stator outer shell is attached to the fixing ends of the star extensions for conjoint rotation with respect to the support disks, as a result of which the stator outer shell is arranged between the support disks. Owing to the stator outer shell being attached to the support disks, the coil units are surrounded by the stator outer shell in a radially covering manner in the circumferential direction. Accordingly, the elements of the stator are fitted from the inside outward.

Further features of the invention can be found in the claims, the figures and the description of the figures. The features and combinations of features mentioned in the description above and the features and combinations of features described below in the description of the figures and/or shown in the figures alone can be used not only in the respectively indicated combination but also in other combinations or on their own, without departing from the scope of the invention.

### BRIEF DESCRIPTION OF THE DRAWINGS

FIG. 1 shows a perspective view of a rotor bearing cylinder for a stator of an axial flux machine,

FIG. 2 shows a perspective view of a support structure for the stator, the support structure having the rotor bearing cylinder and two support disks,

FIG. 3 shows a perspective and partially schematic view of a coil unit for the stator,

FIG. 4 shows a perspective view of the support structure, in which a respective coil unit is radially inserted between two pairs of star extensions of the support disks,

FIG. 5 shows a perspective view of the support structure, in which the coil units are radially clamped in the direction of a rotor shaft bearing by a clamping ring,

FIG. 6 shows a perspective view of the support structure, in which a plurality of busbars are mounted on bar support bodies of the coil units in the circumferential direction, and

FIG. 7 shows a perspective view of the stator.

### DETAILED DESCRIPTION OF THE DRAWINGS

Identical and functionally identical elements are provided with the same reference signs in the figures.

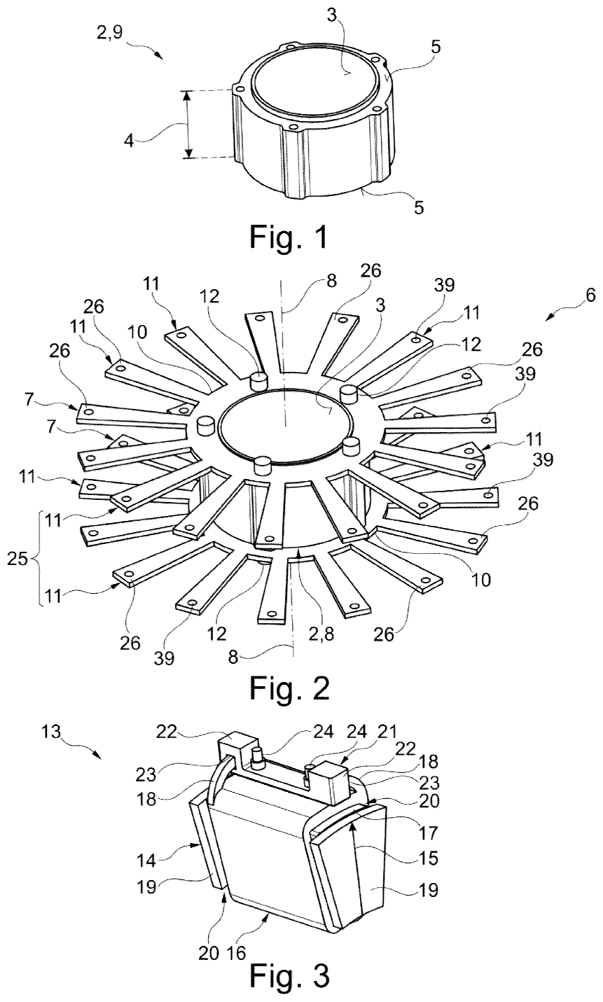

The text below provides a joint description of an electric machine (not illustrated) in the form of an axial flux machine, the stator 1 (see FIG. 7) of the electric machine and a method for producing the stator 1. In this respect, FIG. 1 shows a perspective view of a rotor bearing cylinder 2, the inner circumferential surface 3 of which is designed to function as a bearing point for a rotor (not illustrated) of the axial flux machine. Two end faces 5 of the rotor bearing cylinder 2 are spaced apart from one another in a straight line over a length 4 of the rotor bearing cylinder 2.

FIG. 2 shows a perspective view of a support structure 6 of the stator 1, the support structure 6 having the rotor bearing cylinder 2 and two support disks 7. The support disks 7 are arranged coaxially in relation to each other, that is to say the support disks 7 share a common longitudinal center axis 8. The support disks 7 are axially spaced apart from one another along the longitudinal center axis 8, in the present case over the length 4 of the rotor bearing cylinder 2. Here, the rotor bearing cylinder 2 is arranged coaxially in relation to the two support disks 7, so that the support disks 7 and the rotor bearing cylinder 2 share the longitudinal center axis 8. The longitudinal center axis 8 is, in particular, a longitudinal center axis or rotor axis (not illustrated) of the axial flux machine. Accordingly, the longitudinal center axis 8 and the longitudinal center axis of the rotor coincide. The support structure 6 further has a rotor shaft bearing 9, which is formed by the rotor bearing cylinder 2 in the present example.

The respective support disk 7 has a circular ring portion 10, a large number of-in the present case and merely by way of example fifteen-star extensions 11 extending radially outward away from the circular ring portion, and only a few of the star extensions being provided with the corresponding reference sign in the figure for reasons of clarity.

Here, the support structure 6 is formed by way of the support disks 7 and the rotor bearing cylinder 2 being connected to each other. In the present case, provision is made for the respective support disk 7 and the rotor bearing cylinder 2 to be connected to each other by way of the support disks 7 and the rotor bearing cylinder 2 being screwed to each other, as illustrated in FIG. 2. In FIG. 2, the screw elements 12 required for screw-connecting the respective support disk 7 to the rotor bearing cylinder 2 are not all provided with the corresponding reference sign for reasons of clarity. It is furthermore clear from FIG. 2 that the respective support disk 7 is connected to the rotor bearing cylinder at a respective one of the end faces 5 of the rotor bearing cylinder 2.

FIG. 3 shows a perspective and partially schematic view of a coil unit 13 for the stator 1. The respective coil unit 13 has a radially laminated core 14, which is formed from a large number of individual laminations (not illustrated) which are stacked in the radial direction (see arrow 15 in FIG. 3). A coil insulation casing 17 is arranged between an electric coil 16 of the coil unit 13 and the laminated core 14, the electric coil 16 and the laminated core 14 of the coil unit 13 being electrically insulated from each other by the coil insulation casing. The electric coil 16 of the coil unit 13 has a large number of turns (not illustrated), the coil 16 or the turns ending at two coil ends 18. The laminated core 14 has two end sections 19 which project laterally from the coil 16 along a coil axis (not illustrated) of the electric coil 16. Furthermore, the respective end section 19 of the laminated core 14 projects laterally beyond the coil insulation casing 17, that is to say along the circumferential direction of the stator 1. A gap 20 is formed between the respective end section 19 and the electric coil 16 as a result. The coil 16 is therefore spaced apart from the respective end section 19 by the respective gap 20.

In the present example, the respective coil unit 13 additionally has a respective bar support body 21. The bar support body 21, which is formed from an electrically insulating material, in particular plastic, has two supporting blocks 22, by way of which the bar support body 21 ends along its axial longitudinal extent. In other words, a respective longitudinal end of the bar support body 21 is formed by the respective supporting block 22.

In the present example, provision is furthermore made for the respective bar support body 21 to have two coil contacting elements 23, which are electrically insulated from each other, and two busbar contacting elements 24, which are electrically insulated from each other. Here, the coil contacting elements 23 are each electrically conductively connected to a respective one of the busbar contacting elements 24, for which reason the bar support body 21 has conductor tracks (not illustrated) in the present example. The conductor tracks are embedded into the electrically insulating material of the bar support body 21 and connect the respective coil contacting element 23 and the correspondingly associated one of the busbar contacting elements 24. It can be seen in FIG. 3 that the respective coil end 18 and a respective one of the coil contacting elements 23 are electrically conductively contact-connected to each other, in the present case by way of the corresponding coil end 18 being inserted into the coil contacting element 23 embodied as a coil end receptacle or socket. The busbar contacting elements 24, which are electrically conductively connected to the coil contacting elements 23, are in the form of a respective contacting pin in the present case.

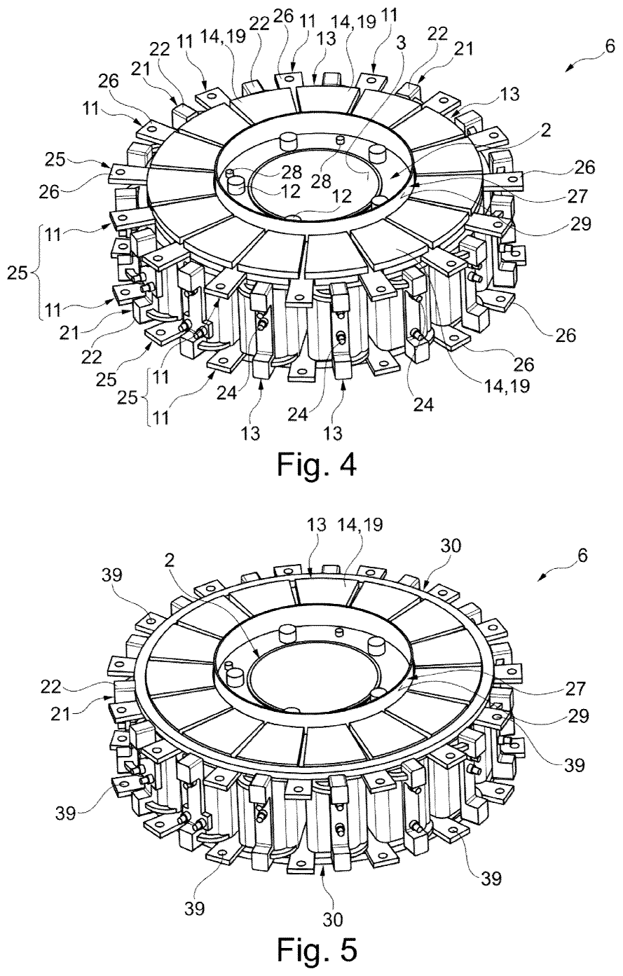

FIG. 4 shows a perspective view of the support structure 6, in which a respective coil unit 13 is radially inserted between two pairs 25 of star extensions (also illustrated in FIG. 2) of the support disks 7. Owing to the radial insertion of the coil units 13 into the support structure 6, the coil units 13 are fixed with respect to the support structure 6 in the circumferential direction by way of the respective coil unit 13 being arranged between the pairs 25 of star extensions, which follow one another in the circumferential direction, of the support disks. In the process, the respective star extensions 11 engage into a corresponding one of the gaps 20 of the coil units 13, so that the end sections 19 of the respective laminated core 14 project beyond the support structure 6 along the longitudinal center axis 8 on both sides. It can furthermore be seen in FIG. 4 that the star extensions 11 are so long in the radial direction that radially external fixing ends 26 of the star extensions 11 project radially outward beyond the coil units 13.

FIG. 4 further shows that, in the present example, the stator 1 has a centering cylinder 27 which is arranged coaxially on the circular ring portion 10 of the support disk 7. Provision can be made for the stator 1 to have two centering cylinders 27, specifically a respective centering cylinder 27 for each support disk 7. In order that the support structure 6, in particular the support disks 7 and the centering cylinder 27, can be aligned in a particularly simple manner and/or with particularly little effort and particularly exactly coaxially in relation to each other, two or more, in the present case three, alignment pins 28 are formed on the circular ring portion 10 of the respective support disk 7, the alignment pins each extending axially, that is to say along the longitudinal center axis 8, outward away from the circular ring portion 10. The centering cylinder 27, which is in the form of a hollow cylinder, likewise extends axially, that is to say parallel to the longitudinal center axis 8, away from the coil units 13, and the coil units 13 are supported by way of their end sections 19 on an outer circumferential surface 29 of the centering cylinder 27.

FIG. 5 shows a perspective view of the support structure 6, as is illustrated in FIG. 4, with the difference that, in the support structure 6 shown in FIG. 5, the coil units 13 are radially clamped in the direction of the rotor shaft bearing 9, that is to say in the direction of the rotor bearing cylinder 2, in the present case in the direction of the centering cylinder 27, by a clamping ring 30. In the example, provision is made for the stator 1 or the support structure 6 to have two clamping rings 30, specifically a clamping ring 30 for each side of the stator 1 and, respectively, for each side of the support structure 6. The clamping ring is clamped around the end sections 19 of the coil units 13 in the circumferential direction, as a result of which the coil units 13 are radially clamped in the direction of the centering cylinder 27 or radially clamped in the direction of the rotor shaft bearing 9. Here, a force-fitting connection, in particular a press-fit, is realized between the end sections 19 of the coil units 13 and an inner circumferential surface (not illustrated) of the respective clamping ring 30. As a result, the end sections 19 and consequently the coil units 13 are clamped between the centering cylinder 27 and the clamping ring 30 in the radial direction. It can furthermore be seen in FIG. 5 that the respective bar support body 21, by its supporting blocks 22, is supported on the clamping ring 30 in the radial direction. This means that the clamping ring 30 has been inserted, for example, between the respective supporting block 22 and a radially external edge of the respective end section 19. As an alternative to this, it is conceivable that the respective coil unit 13 was initially radially inserted into the support structure 6 without the bar support body 21, the clamping ring 30 was then attached and the bar support body 21 was coupled to the coil 16 after this.

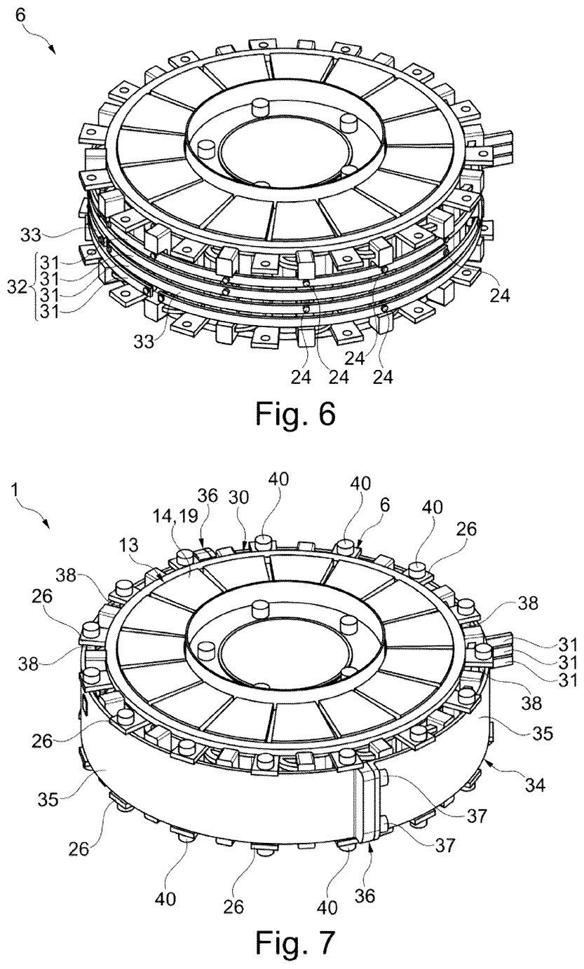

FIG. 6 shows a perspective view of the support structure 6, a plurality of busbars 31 of a busbar arrangement 32 being mounted on the bar support bodies 21 of the coil units 13 in the circumferential direction. This means that the stator 1 has the busbar arrangement 32, that is to say the busbar 31, the busbars 31 being spaced apart from each other in the axial direction. The respective busbar 31, which can be made up of a plurality of busbar segments 33 along the circumferential direction of the stator 1 or the support structure 6, runs around the outer circumference of the coil units 13. In this case, the respective busbar 31 is electrically contact-connected to two or more of the electric coils 16, for example by way of the corresponding busbar 31 being electrically connected, in particular welded, to one or more of the busbar contacting elements 24. In order to prevent a short between the busbars 31, provision is of course made, for each coil unit 13, for a first of the busbars 31 to be electrically conductively connected to a first of the busbar contacting elements 24 and for another or second of the busbars 31 to be electrically conductively connected to the correspondingly other one of the busbar contacting elements 24 of the same coil unit 13.

FIG. 7 shows a perspective view of the stator 1, which has a stator outer shell 34 which is formed from two half-shells 35 in the present case. The two half-shells 35 butt against each other in the circumferential direction by two connecting blocks 36 and in so doing are connected to each other by the connecting blocks 36. The connecting blocks 36 protrude radially from an outer circumferential surface of the stator outer shell 34. In the present example, the two half-shells 35 are screw-connected to each other at the connecting blocks 36. Screw elements involved in screw-connecting the half-shells 35 are identified by reference signs 37 in FIG. 7.

The stator outer shell 34 is arranged between the support disks 7 and surrounds the coil units 13 in a radially covering manner in the circumferential direction. In addition, the stator outer shell 34 or the half-shells 35 is/are connected to the star extensions 11 at the fixing ends 26, so that the stator outer shell 34 and the support structure 6 rotate conjointly. For this purpose, the stator outer shell 34 has screw element receptacles 38, which are arranged so as to correspond to screw element receptacles 39 (see FIGS. 2, 5 and 6) of the fixing ends 26, in the present example. For each pair 25 of star extensions, the stator outer shell 34 has a screw element receptacle 38 on its inner circumferential surface, an associated screw element 40 at the same time extending through two screw element receptacles 39 and the associated screw element receptacle 38 along the longitudinal center axis 8, that is to say axially, in each case. In this way, the stator outer shell 34 is attached to the support structure 6 with particularly reliable conjoint rotation with respect to the support structure 6.

In the present case, the respective bar support body 21 is radially fixed between the clamping rings 30 and the stator outer shell 34 by way of the supporting blocks 22 being clamped in the direction of the clamping rings 30 by the stator outer shell 34. In other words, the bar support body 21 is held between the clamping rings 30 and the stator outer shell 34 as soon as the stator outer shell 34, as intended, surrounds the coil units 13 in the circumferential direction.

The support structure 6 comprising the two support disks 7 is provided in the method for producing the stator 1. The coil units 13 are then arranged between two pairs 25 of star extensions, which are directly adjacent to each other in the circumferential direction, of the support disks 7 or the support structure 6, as a result of which the coil units are fixed with respect to the support structure 6 in the circumferential direction. On account of the respective clamping ring 30 being clamped around the end sections 19 of the coil units 13 in the circumferential direction, the coil units 13 are radially clamped in the direction of the rotor shaft bearing 9. In addition, the stator outer shell 34 is attached to the fixing ends 26 of the star extensions 11 for conjoint rotation with respect to the support disks 7, as a result of which the stator outer shell is arranged between the support disks 7 and the coil units 13 are surrounded by the stator outer shell 34 in a radially covering manner in the circumferential direction.

### LIST OF REFERENCE SIGNS

1 Stator
2 Rotor bearing cylinder
3 Inner circumferential surface
4 Length
5 End face
6 Support structure
7 Support disk
8 Longitudinal center axis
9 Rotor shaft bearing
10 Circular ring portion
11 Star extension
12 Screw element
13 Coil unit
14 Laminated core
15 Arrow
16 Electric coil
17 Coil insulation casing
18 Coil end
19 End section
20 Gap
21 Bar support body
22 Supporting block
23 Coil contacting element
24 Busbar contacting element
25 Pair of star extensions
26 Fixing end
27 Centering cylinder
28 Alignment pin
29 Outer circumferential surface of the centering cylinder
30 Clamping ring
31 Busbar
32 Busbar arrangement
33 Busbar segment
34 Stator outer shell
35 Half-shell
36 Connecting block
37 Screw element
38 Screw element receptacle
39 Screw element receptacle
40 Screw element

1-12. (canceled)

13. A stator for an electric axial flux machine, comprising:
a support structure that has two support disks, which are arranged coaxially in relation to each other and are axially spaced apart from each other, and a rotor shaft bearing, wherein the two support disks each have discrete star extensions that extend radially outward away from a circular ring portion of the support disks;
coil units that are each arranged between two pairs of star extensions, which follow one another in a circumferential direction, of the support disks and directly adjoin the pairs of star extensions, as a result of which the coil units are fixed with respect to the support structure in the circumferential direction,
wherein respective end sections of each laminated core of the coil units project beyond the support structure in the axial direction,
wherein radially external fixing ends of the star extensions project radially outward beyond the coil units;
a clamping ring that is clamped around the end sections of the coil units in the circumferential direction, as a result of which the coil units are radially clamped in the direction of the rotor shaft bearing; and
a stator outer shell that is arranged between the support disks and surrounds the coil units in a radially covering manner in the circumferential direction, and is attached to the fixing ends of the star extensions for conjoint rotation with respect to the support structure.

14. The stator according to claim 13,
wherein the support structure has a rotor bearing cylinder, and a respective support disk is connected to the rotor bearing cylinder at a respective end face of the rotor bearing cylinder, so that the support disks are axially spaced apart from each other over a length of the rotor bearing cylinder.

15. The stator according to claim 13, comprising:
a centering cylinder arranged coaxially on the circular ring portion of the support disk and which extends axially away from the coil units, wherein the coil units, by way of their end sections, are supported on an outer circumferential surface of the centering cylinder and are clamped between the centering cylinder and the clamping ring in the radial direction.

16. The stator according to claim 15,
wherein two or more alignment pins are formed on the circular ring portion of the support disk, the alignment pins each extending outward axially away from the circular ring portion and being designed to assist with coaxially aligning the centering cylinder with respect to the support disk.

17. The stator according to claim 13,
wherein a respective coil unit has a bar support body which is formed from an electrically insulating material and has two supporting blocks at which the bar support body ends along its axial longitudinal extent, wherein the bar support body is radially supported on the clamping ring by the supporting blocks.

18. The stator according to claim 17,
wherein the bar support body is radially fixed between the clamping ring and the stator outer shell by way of the supporting blocks being clamped in the direction of the clamping ring by means of the stator outer shell.

19. The stator according to claim 13,
wherein a respective coil unit has an electric coil and the stator has a busbar arrangement which has, on an outer circumference between the stator outer shell and the coil units, a plurality of busbars which are axially spaced apart from each other, wherein a respective busbar is electrically contact-connected to two or more of the electric coils.

20. The stator according to claim 19,
wherein a respective coil unit has a bar support body, wherein the bar support body has two coil contacting elements that are electrically insulated from each other and are each electrically conductively connected to a respective busbar contacting element of the bar support body, wherein coil ends of the coil are each electrically conductively contact-connected to one of the coil contacting elements, and wherein one of the busbars is electrically conductively connected to one of the busbar contacting elements and another of the busbars is electrically conductively connected to another of the busbar contacting elements.

21. The stator according to claim 20,
wherein respective conductor tracks which electrically conductively connects the respective coil contacting element and the associated busbar contacting element are embedded into the electrically insulating material of the bar support body.

22. The stator according to claim 13,
wherein the stator outer shell has two half-shells which butt against each other and are connected to each other in the circumferential direction by means of two connecting blocks.

23. An axial flux machine comprising:
the stator according to claim 13.

24. A method for producing a stator for an axial flux machine, comprising:
providing a support structure comprising two support disks;
arranging coil units between two pairs of star extensions, which follow one another in a circumferential direction, of the support disks, as a result of which, the coil units are fixed with respect to the support structure in the circumferential direction;
radially clamping the coil units in a direction of the rotor shaft bearing by way of a clamping ring being clamped around end sections of the coil units in the circumferential direction; and
attaching a stator outer shell to fixing ends of the star extensions for conjoint rotation with respect to the support disks, as a result of which the stator outer shell is arranged between the support disks, and the coil units are surrounded by the stator outer shell in a radially covering manner in the circumferential direction.
